(19) United States
(12) Patent Application Publication
(10) Pub. No.: US 2021/0253043 A1
(43) Pub. Date: Aug. 19, 2021

(54) Portable Restroom Trailer and Method of Securing a Portable Restroom to a Trailer

(71) Applicant: Black Tie Products, LLC, Hazel Crest, IL (US)

(72) Inventors: Phillip K. Meegan, New Lenox, IL (US); Scott A. Sherman, Granger, IN (US)

(21) Appl. No.: 17/174,496

(22) Filed: Feb. 12, 2021

Related U.S. Application Data
(60) Provisional application No. 62/976,482, filed on Feb. 14, 2020.

(51) Int. Cl. B60R 15/04; B60P 3/36; B60D 1/46

(52) U.S. Cl. CPC B60R 15/04; B60D 1/465; B60P 3/36

(57) ABSTRACT

A portable restroom trailer includes a frame, a substantially planar surface formed on the frame, a tube secured to the frame, and a securing member that includes a top portion and post portion. The top portion of the securing member is disposed atop an extension portion of a portable restroom and the post portion is disposed in the tube such that the extension portion is entrapped between the top portion and the planar surface.

### CROSS REFERENCE TO RELATED APPLICATIONS

The present application claims benefit of Meegan et al., U.S. Provisional Patent Application Ser. No. 62/976,482, filed Feb. 14, 2020, and entitled “Portable Restroom Trailer.” The entire contents of this application are incorporated herein by reference.

### FIELD OF DISCLOSURE

The present subject matter relates to a mobile trailer, and more particularly, to a mobile trailer to transport portable restrooms.

### BACKGROUND

Portable restrooms are delivered to an event venue before commencement of the event and removed after conclusion of the event. If the event extends over a long duration, used portable restrooms may be replaced periodically during the event. Typically, during transit the portable restroom is loaded onto a trailer (or another carrier) and transported to/from the venue. During transit it is important that the portable restroom be secured to the trailer so that the portable restroom remains stationary on the trailer and also to avoid damage to the portable restroom and/or the trailer.

### SUMMARY

According to one aspect, a portable restroom trailer includes a frame, a substantially planar surface formed on the frame, and a tube secured to the frame. A securing member has a top portion and a post portion. The top portion of the securing member is disposed atop an extension portion of a portable restroom and the post portion of the securing member is disposed in the tube such that the extension portion is entrapped between the top portion and the planar surface.

According to another aspect, a method of securing a portable restroom to a trailer includes forming a substantially planar surface on a frame of trailer. The method further includes disposing a top portion of a securing member atop an extension portion of a portable restroom and disposing a post portion of the securing member in a tube secured to the frame, thereby entrapping the extension portion between the top portion and the planar surface.

Other aspects and advantages will become apparent upon consideration of the following detailed description and the attached drawings wherein like numerals designate like structures throughout the specification.

### BRIEF DESCRIPTION OF THE DRAWINGS

FIG. 1 is an isometric view of a portable restroom trailer;

FIGS. 1A and 1B are views of tie bars that may be used with the portable restroom trailer of FIG. 1;

FIG. 2 is right-side view of the portable restroom trailer of FIG. 1 having portable restrooms disposed thereon;

FIG. 3 is a left-side view of the portable restroom trailer of FIG. 1;

FIG. 4 is a close-up view of portion 4-4 of FIG. 3;

FIG. 5 is an isometric view of the trailer of FIG. 1 in a lifted position;

FIG. 6 is an isometric view of trailer of FIG. 1 with a front portion of the trailer of FIG. 1 lifted further away from the ground than a rear portion thereof; and

FIG. 7 is an isometric view of the trailer of FIG. 1 in a lowered position.

### DETAILED DESCRIPTION

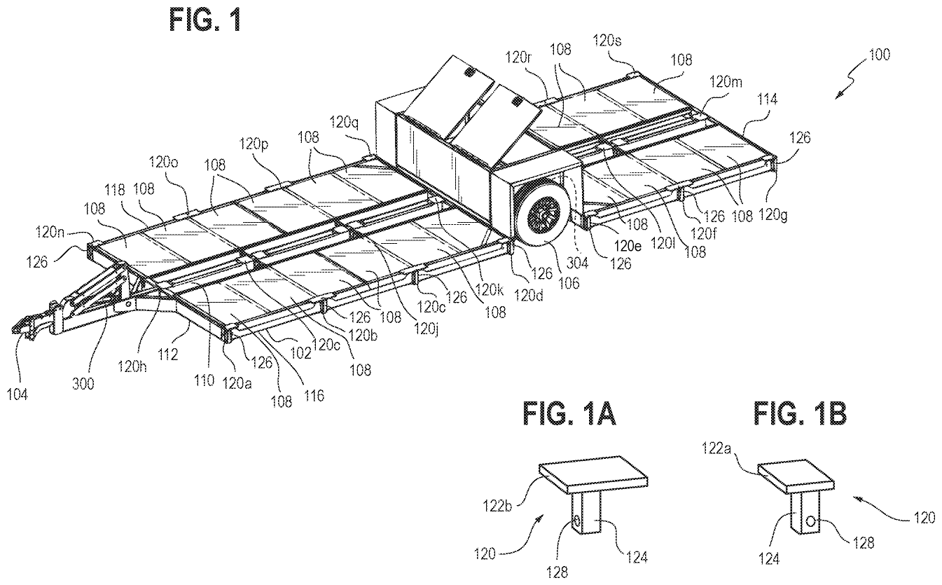

Referring to FIGS. 1, 1A, and 1B, a portable restroom trailer 100 includes a frame 102, and a hitch 104 secured to the frame 102, and plurality of wheels 106 rotatably secured to the frame 102. The hitch 104 may be used to secure the frame 102 to a vehicle (not shown) for transport. As would be understood by one having ordinary skill in the art, the wheels 106 rotate as the trailer 100 is pulled and facilitate transport of the trailer 100 and any contents disposed on or inside the trailer 100.

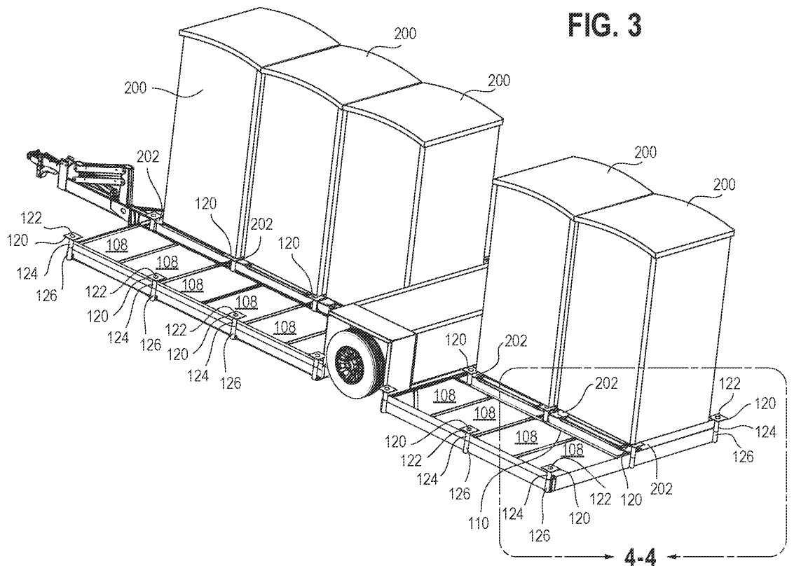

The portable restroom trailer 100 includes a plurality of panels 108 disposed on the frame 102 that provide a planar surface on which to dispose items to be carried by the trailer 100. It should be appreciated that the number of panels shown in FIGS. 1-4 are exemplary and that the portable restroom trailer 100 may include more or fewer panels than shown.

In one embodiment, the panels 108 are disposed to provide a gap 110 therebetween that extends from a front portion 112 to a rear portion 114 of the trailer 100. Further, the gap 110 is generally disposed half-way between a right-side 116 and a left-side 118 of the trailer 100.

A plurality of spaced apart securing members or tie bars 120 are disposed apart along a perimeter 122 of the trailer 100 and along the gap 110. As shown in FIG. 1A and FIG. 1B, each tie bar 120 includes a substantially planar top portion 122 secured to a post 124.

In one embodiment, some tie bars 120, for example, tie bars 120a, 120d, 120e, 120g, 120h, 120k, 120m, 120n, 120q, and 120s have generally square top portions 122a (as shown in FIG. 1A), and other tie bars 120, for example, 120b, 120c, 120f, 120i, 120j, 120l, 120o, 120p, and 120r have generally elongated or rectangular top portions 122b (as shown in FIG. 1B). In other embodiments, all of the tie bars 120 disposed on the trailer 100 may have square top portions 122a or all of the tie bars 120 may have rectangular top portions 122b. Any combination of tie bars 120 having square top portions 122a and rectangular top portions 122b may be used in still other embodiments.

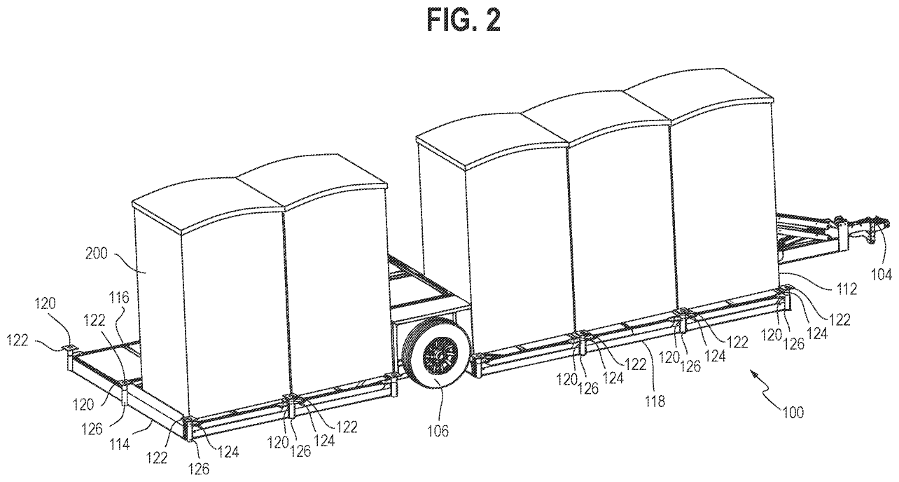

To dispose a tie bar 120 on the trailer 100, the post portion 124 of such tie bar 120 is disposed in a corresponding tube 126 secured to the frame 100. Each tie bar 120 is movable within the tube 126 in which it is disposed between a seated position (shown in FIG. 1) in which the top portion 122 of the tie bars is in contact with or proximate to the panel 108 to a raised position (shown in FIG. 2) in which the top portion 122 is spaced apart from the panel 108.

Referring to FIGS. 2-4, one or more portable restrooms 200 may be disposed on top of the panels 108. Each restroom 200 includes a plurality of extension portions 202 that extend outwardly from the restroom 200. Typically, such extension portions 202 are coupled to the floor (not shown) the restroom 200.

To secure the restroom 200 to the trailer 100, the restroom 200 is placed on the trailer 100 so that one or more of the tie bars 120 are aligned with corresponding extension portions 202 extending outwardly from the restroom 200. Each tie bar 120 aligned with an extension portion 202 is moved to the raised position so that the top portion 122 of such tie bar 120 extends beyond the extension portion 202. The restroom 200 is positioned so that the extension portion 202 is between the panel 108 and the top portion 122 of the raised tie bar 102. The tie bar 120 is then lowered toward the panel 108 such that the extension portion 202 is entrapped between the top portion 122 of the tie bar 120 and the panel 108, and thus, the frame 102.

In some embodiments, the tie bar 120 is removed from the tube 126 in which the tie bar 120 is disposed. The restroom 200 is then positioned on the panel 108 such that the extension portion 202 is adjacent the tube 126, the post portion 124 of the tie bar 120 is inserted into the tube 126, and the tie bar 120 is lowered until the top portion 122 of the tie bar rests on the extension portion 202.

Each tube 126 includes one or more orifices 204. After the extension portion 202 of the restroom 200 is entrapped between the tie bar 120 and the panel 108, a securing device such as a fastener (not shown), for example, a bolt, a screw, a zip tie, and the like, is inserted into one or more such orifice 204 and through a receiving orifice (not shown) in the post 124 of the tie bar 120 to fixedly secure the tie bar 120 to the panel 108. Securing the tie bar 120 to the tube 126 (and thus the frame 102) prevents movement of the restroom 200 secured thereby. It should be apparent, that if a zip tie or similar fastener is used, such zip tie may be passed through a first orifice 204 in the tube 126, a corresponding orifice in the post 124, and through a second orifice (not shown) in the tube 126 disposed opposite the first orifice and tied off.

Alternately, in some embodiments, each tube 126 includes a plurality of orifices and the securing device disposed in the post 124 of each tie bar 120 includes a spring-loaded pin or button spring 128 that is moveable between a depressed position and an extended position. When the pin 128 is pushed upon, the pin 128 is urged toward the interior of the post 124 and into the depressed position. When not pushed upon, the pin 128 is in the extended position and extends outwardly from the post 128. When the post 124 is inserted into the tube 126, the pin 128 is held in the depressed position by a wall of the post 124 until the pin 128 is aligned with one of the plurality of orifices. When so aligned, the pin 128 moves into the extended position and protrudes into the orifice. In such embodiment, to secure the extended portion 202 of the restroom 200, the top portion 122 of the tie bar 120 is aligned with the extended portion 202 as described above and the post 124 is pushed into the tube 126 until the pin 128 on the post 124 is aligned with and protrudes into the orifice of the tube 126. Thereafter, friction between the pin 128 and the orifice walls (not shown) holds the tie bar 120 in place and secures the extended portion 202 of the restroom 200.

Other ways of securing the tie bar 120 to the tube 126 will be apparent to one who has ordinary skill in the art may be used.

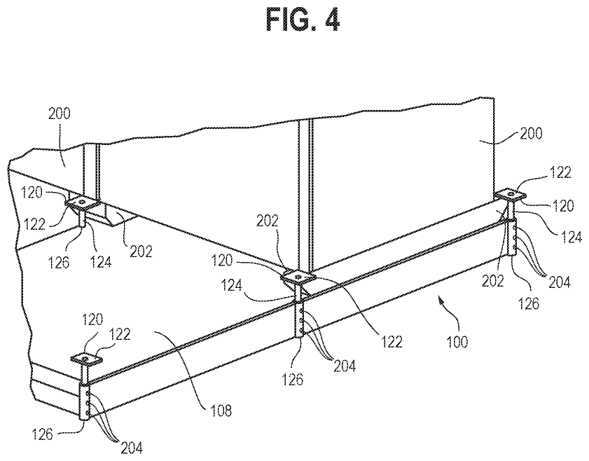

Referring to FIGS. 1 and 5-7, in some embodiments a first pneumatic lift system 300 may be disposed proximate the front portion 112 of the trailer 100 (for example, proximate the hitch 104). The front portion 112 may be secured to a jack post 302 (see FIGS. 4-6) or to a vehicle (not shown) and operated to lift or lower the front portion 112 of the trailer relative to the jack post 302 or the vehicle and, therefore, the ground.

A second pneumatic lift system 304 may be disposed proximate the wheels 106 and operated to lift or lower the trailer 100 relative to the wheels 106, and therefore the ground.

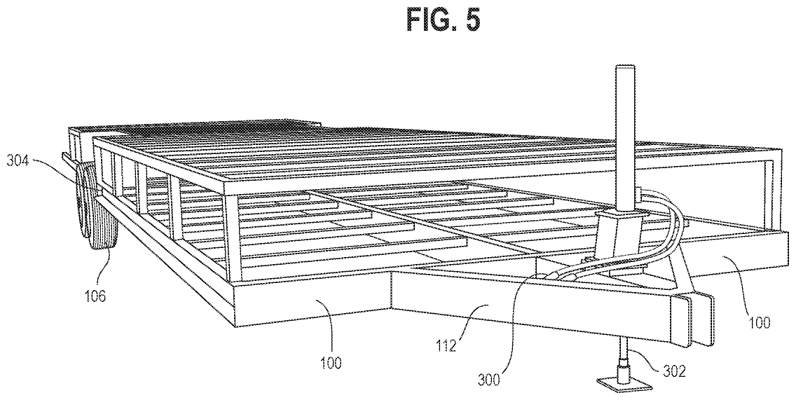

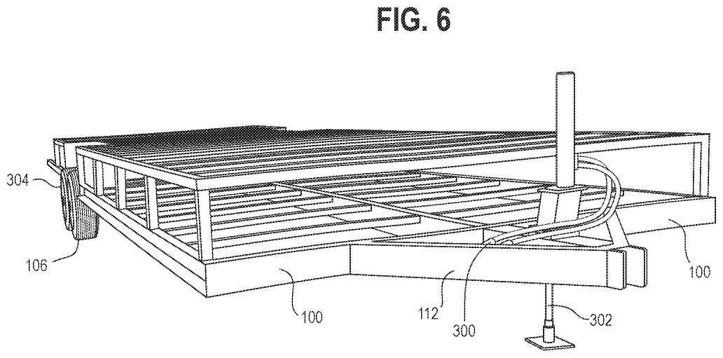

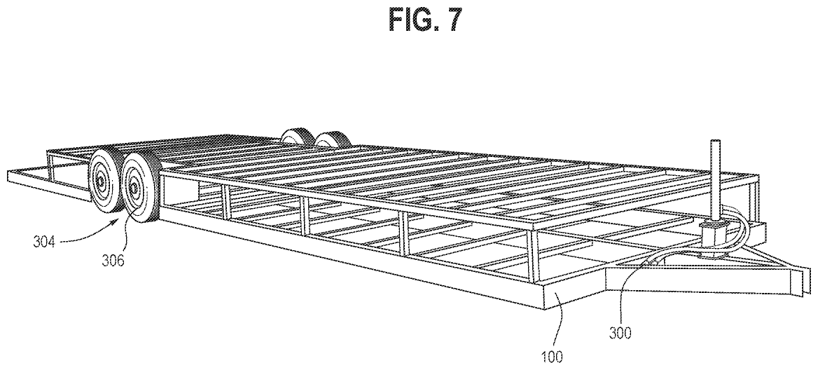

FIG. 5 shows the trailer lifted relative to both the jack post 302 and the wheels 106. FIG. 6 shows the front portion 112 of the trailer 100 having been lifted further away from the ground than a portion 306 of the trailer 100 proximate the wheels 106. FIG. 7 shows the trailer 100 having been lowered to be proximate to the ground in comparison to the positions of the trailer 100 shown in FIGS. 5 and 6. The distances from the ground of the front portions of the trailer and the portion of the trailer proximate the wheels 106 may be adjusted as shown in FIGS. 5-7, and to other distances, by operating one and/or both of the first and second pneumatic lift systems 300 and 304, respectively.

### INDUSTRIAL APPLICABILITY

The trailer disclosed herein facilitates securing portable restrooms thereon so that, once secured by the tie bars, the portable restroom remains stationary during transport to a destination. Although the area of the planar surface of the trailer may determine a maximum number of portable restrooms that may be secured to the trailer and transported, it should be apparent that as few as one portable restroom may be secured to and transported using the trailer. Further, it should be apparent that upon arrival at the destination, a subset of portable restrooms disposed on the trailer may be unsecured and unloaded from the trailer by removing only those tie bars that secure such subset. That is, all of the portable restrooms on the trailer do not have to be unsecured to unload a fewer number of portable restrooms than the total number of portable restrooms disposed on the trailer.

Although the embodiments of the trailer are described herein for the secure transport of portable restrooms, it should be apparent to one who has ordinary skill in the art that any other object may be secured to a trailer as described herein by entrapping one or more portions of such object between the top portion of the tie bar and the frame of the trailer.

All references, including publications, patent applications, and patents, cited herein are hereby incorporated by reference to the same extent as if each reference were individually and specifically indicated to be incorporated by reference and were set forth in its entirety herein.

The use of the terms “a” and “an” and “the” and similar references in the context of describing the invention (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Numerous modifications to the present disclosure will be apparent to those skilled in the art in view of the foregoing description. It should be understood that the illustrated embodiments are exemplary only, and should not be taken as limiting the scope of the disclosure.

We claim:

1. A portable restroom trailer, comprising:
a frame;
a substantially planar surface formed on the frame;
a tube secured to the frame;
a securing member, wherein the securing member includes a top portion and a post portion; and
wherein the top portion of the securing member is disposed atop an extension portion of a portable restroom and the post portion of the securing member is disposed in the tube such that the extension portion is entrapped between the top portion and the planar surface.

2. The portable restroom trailer of claim 1, further including at least one panel disposed on the frame to form the substantially planar surface.

3. The portable restroom trailer of claim 1, further including a securing device to secure the securing member to the tube.

4. The portable restroom trailer of claim 3, wherein the tube includes a first orifice and the post portion includes a second orifice and a fastener is passed through the first and second orifices to secure the securing member to the tube.

5. The portable restroom trailer of claim 3, wherein the securing device comprises a spring-loaded pin disposed on the post portion and the pin extends through an orifice in the tube when the securing member is secured to the tube.

6. The portable restroom trailer of claim 1, further including a hitch disposed proximate a first portion of the trailer, a plurality of wheels disposed proximate a second portion of the trailer, a first pneumatic lift system disposed proximate the hitch, and a second pneumatic lift system disposed proximate the wheels.

7. The portable restroom trailer of claim 1, wherein the substantially planar surface comprises a first substantially planar surface, further including a second substantially planar surface formed on the frame and spaced apart from the first substantially planar surface.

8. The portable restroom trailer of claim 7, wherein the first and second substantially planar surfaces are disposed to form a gap therebetween that extends from a front portion of the trailer to a rear portion of the trailer.

9. The portable restroom trailer of claim 8, wherein the securing member includes a first securing member, and further comprising a second securing member disposed in the gap to entrap the extension portion between the second securing member and the first surface.

10. The portable restroom trailer of claim 1, wherein the top portion of the securing member is substantially planar.

11. A method of securing a portable restroom to a trailer, comprising:
forming a substantially planar surface on a frame of trailer;
disposing a top portion of a securing member atop an extension portion of a portable restroom; and
disposing a post portion of the securing member in a tube secured to the frame, thereby entrapping the extension portion between the top portion and the planar surface.

12. The method of claim 11, further including the step of disposing at least one panel on the frame to form the substantially planar surface.

13. The portable restroom trailer of claim 11, further including securing the securing member to the tube using a securing device.

14. The method of claim 13, wherein securing the securing member includes passing the securing device through a first orifice in the tube and a second orifice in the post portion.

15. The method of claim 13, wherein the securing device comprises a spring-loaded pin disposed on the post portion and inserting the post portion into the tube until the pin extends through an orifice in the tube.

16. The method of claim 11, further including disposing a hitch proximate a first portion of the trailer, disposing a plurality of wheels proximate a second portion of the trailer, disposing a first pneumatic lift system proximate the hitch, and disposing a second pneumatic lift system disposed proximate the wheels.

17. The method of claim 1, wherein the substantially planar surface comprises a first substantially planar surface, further including forming a second substantially planar surface on the frame that is spaced apart from the first substantially planar surface.

18. The method of claim 17, further including forming the first and second substantially planar surfaces to create a gap therebetween that extends from a front portion of the trailer to a rear portion of the trailer.

19. The method of claim 18, wherein the securing member includes a first securing member, and further comprising disposing a second securing member in the gap and entrapping the extension portion between the second securing member and the first surface.

20. The method of claim 11, wherein the top portion of the securing member is substantially planar.
